(19) United States
(12) Patent Application Publication
(10) Pub. No.: US 2026/0241739 A1
(43) Pub. Date: Aug. 20, 2026

(54) STEREOSCOPIC STORY BOOK

(71) Applicant: Hae-Yong CHOI, Seoul (KR)

(72) Inventor: Hae-Yong CHOI, Seoul (KR)

(21) Appl. No.: 19/414,696

(22) Filed: Dec. 10, 2025

(30) Foreign Application Priority Data
Dec. 30, 2024 (KR) 10-2024-0200822

(51) Int. Cl. B42D 1/00; B42D 1/08; G02B 30/34

(52) U.S. Cl. CPC B42D 1/009; B42D 1/08; G02B 30/34

(57) ABSTRACT

The present invention relates to a stereoscopic story book, comprising a stereoscopic viewer and stereoscopic left and right images configured by multiple book pages, with a front cover, a back cover, and a storage case for housing the stereoscopic viewer, an entire structure being configured in a form of the stereoscopic story book, wherein the stereoscopic viewer comprises left and right horizontal supports having a rectangular frame structure around a periphery with an exposed center and connected to the bottom of a central support (209) with a hinge, and the book page comprises multiple pages configured in a successively folded W-shape, with interior surfaces adhered to each other to form a single book page, and one side of the exterior surfaces comprising multiple left and right images arranged as a stereoscopic image unit, whereby during use, the surfaces of the left and right horizontal supports of the stereoscopic viewer horizontally align with the left and right images while simultaneously aligning the focus of the left and right lenses, thereby enabling application to short, medium, and full-length stereoscopic cartoons and stereoscopic novels that provide stories.

### TECHNICAL FIELD

The present invention relates to a stereoscopic story book capable of providing stories by combining a stereoscopic story book having pages folded in a W-shape with a stereoscopic viewer having left and right horizontal supports provided on the surface of the stereoscopic story book to provide multiple stereoscopic screens and multiple texts.

### BACKGROUND ART

There is an emerging need for stereoscopic cartoons and stereoscopic graphic novels with stories.

Typically, a novel requires a manuscript of at least 70 sheets of 200-character paper, and a cartoon must comprise at least 10 pages or more of sequential pictures to present a story.

However, conventional stereoscopic related story books had a structure that allowed stereoscopic cards to be viewed as single pages and could not provide continuous stereoscopic images, and the accompanying texts and sentences were also limited in space, making it impossible to provide stories.

Furthermore, it could not be applied to novels providing lengthy stories with numerous pages or to cartoons developing stories through multiple illustrations, and thus could not be applied to new stereoscopic story books containing multiple textual contents such as stereoscopic science fiction novels, stereoscopic cartoons, architectural engineering texts, and science introductions.

Even in stereoscopic methods, a conventional red-cyan scheme cannot implement color, and a lenticular system suffers from reduced resolution resulting in diminished realism. Additionally, a method for observing stereoscopic images with left and right observation lenses becomes impossible for stereoscopic observation even when a focal length of the observation lenses differs by only 0.5 mm.

Furthermore, as illustrated in a reference diagram of FIG. 5, conventional story books such as cartoons or novels having a large number of pages have book pages that unfold to the left and right based on a book spine (Seneka) formed as a curved surface, so that a focal length between the page surface and the left and right lenses does not match, making it impossible to observe the stereoscopic images.

A stereoscopic story book of KR application No. 2019920013634, having the same inventor as the present invention, could not be put to practical use because super stereoscopic observation itself was impossible due to deviation in focal length resulting from page thickness when turning over pages on a page-by-page basis.

Furthermore, since a stereoscopic picture must be turned over on a single-page basis, text lacks continuity, making it impossible to apply to cartoons or graphic novels where stories are connected because the story is interrupted on each page, and no method was provided for the observation lens to be horizontal in the same manner as the horizontal plane of the stereoscopic picture.

Furthermore, a stereoscopic story book of KR application No. 2019920012251, having the same inventor as the present invention, could not be applied to full-length stereoscopic cartoons, full-length stereoscopic graphic novels, and the like, because the focal length of the lens does not match even when turning over only one page, so that stereoscopic images are limited to single-page units and continuous stereoscopic image provision is impossible.

Therefore, these existing stereoscopic technologies could not be applied to novels, graphic novels, and cartoons that provide text for stories which constitute the majority of publications, to create new stereoscopic graphic novels or stereoscopic cartoons.

### DISCLOSURE

### Technical Problem

In view of the above problems, the present invention provides a method for configuring new short, medium, and full-length cartoons and graphic novels as stereoscopic story books by continuously providing multiple texts and a large volume of stereoscopic images, and configuring a focus of a stereoscopic observation lens to match a stereoscopic image for each stereoscopic image.

### Technical Solution

A configuration of a book page according to the present invention increases the number of page surfaces of a story book by means of pages that are successively folded in multiple W shapes on which stereoscopic image surfaces are formed.

Interior both surfaces of the W-shaped story book are folded with adhesive surfaces to constitute a book spine (Seneka), and a portion where both external surfaces of the story book are folded is used as a central fold line to constitute left and right stereoscopic images and texts on both surfaces thereof.

A structure of the story book is configured such that one side of the central fold line is connected to a book spine fold line, and the book spine fold line is sequentially connected to the central fold line, whereby each time a page is turned over along the central fold line about a book spine as an axis, the surfaces of the stereoscopic left and right images are provided in a horizontal state without curvature.

Left and right stereoscopic viewers, which move in close contact with the surfaces of the left and right images in the horizontal state, comprise left and right lenses at the top of a central support and left and right horizontal supports at the bottom formed by rectangular frames, wherein an interior of a rectangular frame is configured to expose the left and right stereoscopic images.

The size of the left and right stereoscopic images and the size of the interior of the left and right horizontal supports are configured to be the same as each other, and the length of the central support is configured to be the same as the focal length of the left and right lenses.

Further, the story book and the stereoscopic viewer are combined with a book cover comprising a front cover, a back cover, and a book spine (Seneka) to form a single stereoscopic story book structure.

Further, the stereoscopic viewer including the left and right horizontal supports and a book cover structure are combined to constitute a separate story book.

Further, a book page in which an interior surface among W-shaped paper surfaces is adhered and an exterior surface becomes a stereoscopic image surface, and the book cover structure are combined to constitute a separate story book.

### Advantageous Effects

According to the present t invention, it is possible to continuously extend paper surfaces in which a stereoscopic image surface is successively folded in multiple W-shapes as many pages as required.

According to the present invention, surfaces of multiple left and right images can be observed as stereoscopic images as a stereoscopic viewer moves across the surfaces of the multiple left and right images.

Additionally, in a W-shaped story book where both interior surfaces are adhered as one page and both external surfaces are sequentially folded along a central fold line, the stereoscopic image surface remains horizontal each time a page is turned over about a book spine as an axis.

Left and right horizontal supports, comprising left and right lenses at the top of a central support and rectangular frames at the bottom, are in close contact with the stereoscopic image surface horizontally so that focal lengths of the left and right lenses align with the stereoscopic image surface.

Furthermore, left and right horizontal supports having interior centers identical in size to the left and right images maintain fixed focus of the left and right lenses and alignment with viewing angles of the left and right lenses even when the stereoscopic viewer freely moves across the stereoscopic image surface, thereby facilitating stereoscopic observation.

Additionally, the length of the central support that is equal to the focal length of the left and right lenses automatically aligns the focal lengths of the left and right lenses.

Therefore, the left and right horizontal supports of the present invention are always horizontally aligned based on the focal length of the left and right lenses, so that during use, the left and right horizontal supports of the stereoscopic viewing device and the left and right image surfaces of the stereoscopic page are in close contact horizontally to be aligned, and simultaneously the focus of the left and right lenses automatically aligns with the surfaces of the left and right image surfaces.

Furthermore, by configuring a size of an internally exposed area of the left and right horizontal supports to be identical to the size of the left and right image surfaces of the stereoscopic page, the stereoscopic viewer enables observation of stereoscopic images while freely moving the stereoscopic image surface of the stereoscopic story book in upward, downward, leftward, and rightward directions.

By providing the stereoscopic images horizontally in this manner, the left and right images that align with the left and right horizontal supports achieve maximum focus extending to corners within the field of view range of the left and right lenses, thereby enabling provision of a large stereoscopic screen that is more than 10 times a stereoscopic area compared to the conventional screen.

Therefore, the present invention allows multiple stereoscopic images and texts per page to be continuously provided in large quantities, so that it can be applied to short, medium, and full-length stereoscopic cartoons, science fiction novels, stereoscopic novels and stereoscopic educational materials.

Furthermore, the stereoscopic viewer is housed within the stereoscopic story book and configured as a single book structure, thereby facilitating distribution and storage as a book.

### DESCRIPTION OF DRAWINGS

FIG. 1 is an explanatory diagram of a configuration according to the present invention.

FIG. 2 is an explanatory diagram of an external structure according to the present invention.

FIG. 3 is an explanatory diagram of components according to the present invention.

FIG. 4 is an explanatory diagram of a page surface configuration according to the present invention.

FIG. 5 is a reference diagram illustrating a surface condition when viewing a conventional story book.

FIGS. 6A, 6B, and 6C are explanatory diagrams of a W-shaped paper surface configuration according to the present invention.

FIGS. 7A, 7B, and 7C are explanatory diagrams illustrating an operation in which a story book maintains a horizontal position according to the present invention.

FIG. 8 is an explanatory diagram illustrating a combination of a page surface of a stereoscopic story book and a stereoscopic viewer.

FIG. 9 is an explanatory diagram illustrating a configuration of the stereoscopic viewer.

FIGS. 10A, 10B, and 10C are explanatory diagrams of an operation of the stereoscopic viewer.

FIGS. 11A and 11B are explanatory diagrams illustrating surface shapes of an existing story book and the story book according to the present invention.

### BEST MODE

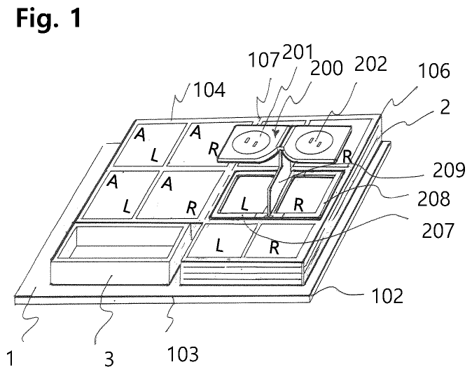

The present invention is characterized in that a stereoscopic image surface 106 provided horizontally (or in a flat form) for each book page and a stereoscopic viewer 200 which moves to the horizontal stereoscopic image surface 106 are horizontally in close contact with each other to be observed as a stereoscopic image, as illustrated in FIG. 1, and each configuration is described in detail according to the drawing.

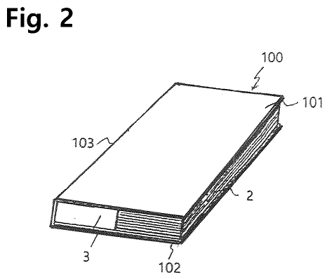

The present invention has a configuration of a stereoscopic story book 100 in the form of a single story book consisting of a front cover 101, a book spine 103, and a back cover 102, as illustrated in FIG. 2. Inside the stereoscopic story book 100, an entire structure is configured as a stereoscopic story book 100 structure, which includes a book page 2 having a stereoscopic image, a text surface 105 having contents related to the stereoscopic image surface 106, a stereoscopic viewer 200, and a storage case 3 storing the stereoscopic viewer 200.

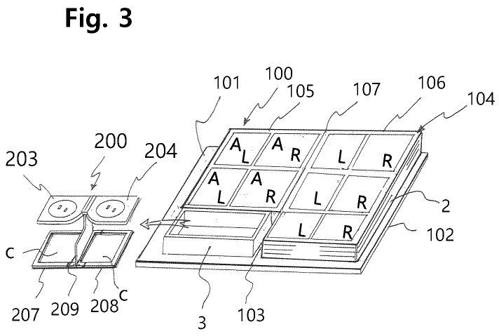

As illustrated in FIG. 3, a central fold line 107 is formed in the middle of a page surface 104 and, based on this, a text-mainly text surface A or a stereoscopic left image L and a stereoscopic right image R is formed on one side of the left and right sides, and the stereoscopic left image L and the stereoscopic right image R are formed on the stereoscopic image surface 106 on one side (right side).

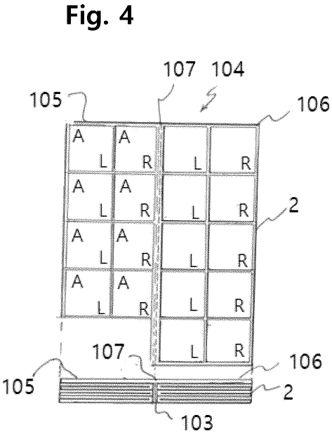

For example, as illustrated in FIG. 4, the text surface A is formed on each page surface, and on the left surface, the left image L of a left-eye image and the right image R of a right-eye image, which are produced for stereoscopic purposes related to the text surface A, are sequentially formed, and these left and right images L and R are formed in the same number in the up and down direction or left and right direction as one image unit.

Furthermore, in cases where dialogue characters and stereoscopic pictures are represented at the same time, such as in stereoscopic cartoons, an entire surface may be configured as a stereoscopic image surface 106.

The sizes of the left and right images L and R illustrated in FIG. 4 are based on center of the left image L and the right image R, respectively, the left and right spacing is within 60 MM to 65 MM, and a total horizontal size of the left and right images is within 130 MM. Upper and lower sizes of the left and right images L and R are within 20 MM to 80 MM depending on a total size of the book and editing.

In a conventional red-cyan stereoscopic scheme, since images are synthesized through a color filter, colors are changed to black and white levels, and the resolution deteriorates. The 3D observation structure of the present invention is a structure for observing the stereoscopic image in natural color as it is through the left and right lenses, so when a distance between left and right eyes of a person exceeds 65 mm, the stereoscopic image appears as a double image, and when the distance between the left and right eyes is less than 60 mm, a screen becomes smaller and thus a stereoscopic effect decreases, and when a top and bottom size is less than 20 mm, the screen becomes smaller and thus a stereoscopic sensation decreases, and when the distance between the left and right lenses is more than 80 mm, the field of view of left and right lenses 201 and 202 is exceeded, so a part of image is cut.

In regard to such a configuration, a total of 10 stereoscopic images may be configured in one page when the size of the stereoscopic image surface 106 is configured on an A4 paper size as illustrated in FIG. 4, with left and right image units L and R as one stereoscopic image unit arranged in two stereoscopic images in the left and right direction and five stereoscopic images in the up and down direction.

Therefore, when the stereoscopic image surface 106 is composed of 100 pages, a total of 1000 stereoscopic images may be provided, so that sufficient story contents may be provided when applied to stereoscopic cartoons and the like. Therefore, interruption of the story may be prevented when presenting a stereoscopic screen as a single chapter, thereby enabling full-length stereoscopic cartoons, full-length stereoscopic novels, and the like.

In the present invention, as illustrated in FIG. 1, the stereoscopic viewer 200 observes stereoscopic images while freely moving over the stereoscopic image surface 106 on the surface of the book page 2 according to a story sequence.

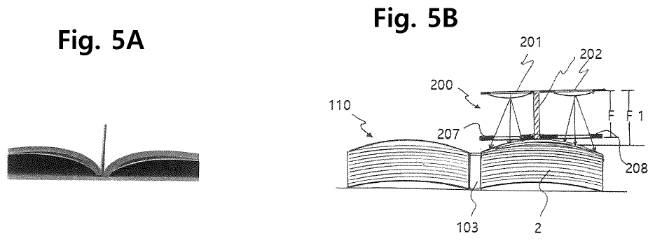

However, as illustrated in FIGS. 5A and 5B, in existing story books, the more pages there are, the more the book pages become curved, causing the focal length F between the left and right horizontal supports 207 and 208 and the left and right lenses 201 and 202 of the stereoscopic viewer 200 to become inconsistent with a peripheral focal length F1, thereby making stereoscopic image observation impossible.

That is, as illustrated in FIG. 5B, such a stereoscopic viewer 200 causes the image to become blurred even when the focal length F of the left and right lenses 203 and 204 deviates by only 0.2 mm, which is the thickness of a book page. In particular, in the case of the stereoscopic story book 100, when the focus is incorrect, a user may even experience symptoms of dizziness.

Therefore, the present invention should be configured to be horizontal so that the focuses of the left and right lenses 201 and 202 may always be aligned on the stereoscopic image surface 106 even when the page is moved to another page.

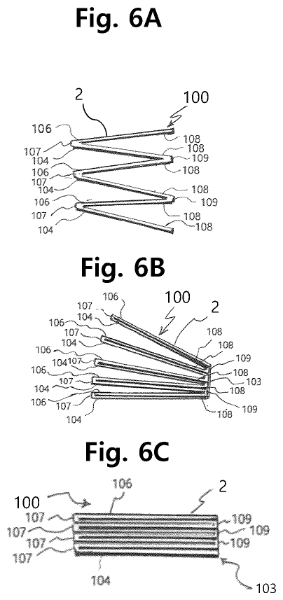

For this purpose, as illustrated in FIGS. 6A, 6B, and 6C, the stereoscopic story book 100 is configured by configuring an entire structure of the book page 2 in a W-shape and folding page surface continuously as many pages as necessary.

As illustrated in FIG. 6A, interior adhesive surfaces 108 that face each other inside the W-shaped paper surface are adhered to each other, and the adhered portions thus formed constitute book spine fold lines 109. The book spine fold lines 109 are assembled to form the book spine 103 as illustrated in FIG. 6C.

As illustrated in FIG. 6B, an exterior paper surface of the W-shape comprises a text surface 105 on one of the exterior left and right sides and a stereoscopic image surface 106 on the other side, and the fold line between the left and right sides where both sides are folded is defined as a central fold line 107.

That is, the W-shaped paper surface has the interior adhesive surface 108 that is folded and adhered as one page, and the right side of the exterior of the adhered paper surface forms the central fold line 107, as illustrated in FIGS. 6A and 6B, and the left side of an interior where the interior adhesive surface 108 connects the pages is connected to the book spine fold line 109 to constitute the book spine 103 as illustrated in FIGS. 6B and 6C.

As illustrated in FIG. 6C, in the present invention, one side comprises the spine fold lines 109 that are gathered to form the book spine 103, and the other side comprises the central fold line 107 that forms page units of the book page unit.

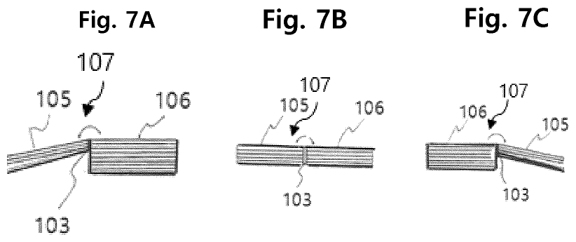

Therefore, as illustrated in FIGS. 7A, 7B, and 7C, each time the pages of the text surface 105 and the stereoscopic image surface 106 are turned over about the book spine 103 as the axis, the surfaces of the left and right images L and R are provided in a flat state without curvature.

That is, as illustrated in FIG. 7A, when the central fold line 107 is unfolded leftward about the book spine 103 as the axis, the left page surface having fewer pages becomes inclined while the right page surface having more pages becomes horizontal.

As illustrated in FIG. 7B, when the book page 2 has the same number of pages on both sides of the central fold line 107 about the book spine 103 as the axis, both the left and right sides become horizontal.

As illustrated in FIG. 7C, when the surface of the page surface 104 is unfolded rightward, the left page surface 104 becomes horizontal.

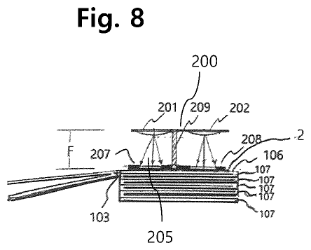

Therefore, in such a stereoscopic story book 100, as illustrated in FIG. 8, regardless of how many pages the stereoscopic image surface 106 has, one or both sides become horizontal about the central fold line 107, so that the stereoscopic viewer 200 becomes horizontal to the stereoscopic image surface 106.

However, in order for the stereoscopic viewer 200 and the stereoscopic image surface 106 to be in close contact and maintain a horizontal position, the stereoscopic viewer 200 must also be configured with a device that holds the stereoscopic viewer 200 horizontal with respect to the stereoscopic page surface 106.

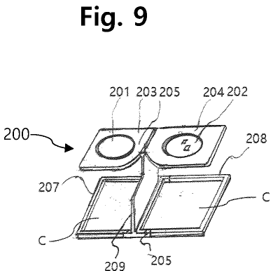

Therefore, as illustrated in FIG. 9, the stereoscopic viewer 200 of the present invention comprises a left lens plate 203 equipped with a left lens 201 and a right lens plate 204 equipped with a right lens 202 at an upper end about a central support 209, each connected to the central support 209 by hinges 205.

At a lower end of the central support 209, a left horizontal support 207 and a right horizontal support 208, each having a frame structure on all four sides with an open center, are respectively connected to the left and right sides of the central support 209 by the hinges 205.

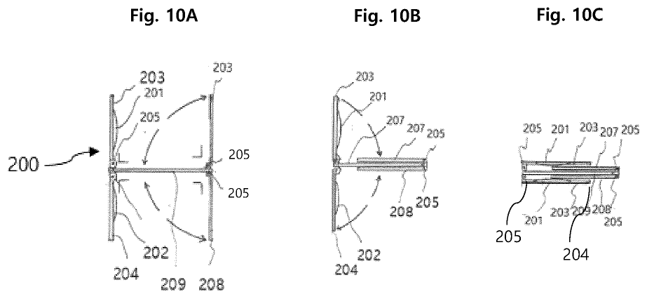

As illustrated in FIG. 10A, the left and right horizontal supports 207 and 208 are configured to be unfolded and folded at a 90-degree right angle about the lower end of the central support 209 as the axis, and the left and right lens plates 203 and 204 are configured to be unfolded and folded at the upper end of the central support 209.

The left and right horizontal supports 207 and 208 are connected to the hinge 205 as illustrated in FIG. 8, and when unfolded left and right, are formed at right angles to the left and right images L and R and thus configured to be horizontal to the left and right lenses 201 and 202, thereby making horizontally close contact with the surfaces of the left and right images L and R.

An interior exposed surface c of frames of the left and right horizontal supports 207 and 208 is configured to be the same size as the left and right images L and R formed on the stereoscopic image surface 106, as illustrated in FIG. 4.

A reason for configuring the exposed surfaces c of the left and right horizontal supports 207 and 208 to be the same size as the left and right images L and R is to align the centers of the plurality of left and right images L and R with the centers (optical axes) of the left and right lenses 201 and 202.

Furthermore, by configuring a length of the central support plate 206 to be the same as the focal length F of the left and right lenses 201 and 202, when the left and right lens plates 203 and 204 and the left and right horizontal supports 207 and 208 are unfolded as illustrated in FIGS. 9 and 10, the focal length F of the left and right lenses 201 and 202 automatically aligns with the stereoscopic image surface 106 as illustrated in FIG. 8.

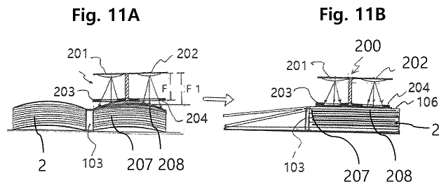

Therefore, the present invention, as illustrated in FIG. 11B, ensures that the optical axes, which are the center of the user's left and right eyes, align with the center of the left and right lenses 201 and 202, and a center spacing matches that of the left and right images L and R, while the left and right horizontal supports 207 and 208 remain horizontally aligned and in close contact with the stereoscopic image surface 106 of the stereoscopic story book 100.

Furthermore, the stereoscopic story book 100 of the present invention, which is configured by continuously folding the W-shaped interior paper surface to the interior adhesive surface 108 as illustrated in FIG. 6A, enables observation of stereoscopic images by always moving horizontally and closely contacting with the left and right horizontal supports 207 and 208 of the stereoscopic viewer 200 as illustrated in FIG. 8.

Therefore, the present invention addresses the problem illustrated in FIG. 11A where the conventional story book does not align with the surfaces of the left and right horizontal supports 207 and 208 of the stereoscopic viewer, and as illustrated in FIG. 11B, even when turning over the surface of the stereoscopic story book 100, each page maintains the same horizontal alignment, and the left and right lenses 201 and 202 and the left and right images L and R are always in close contact and aligned horizontally, thereby enabling observation of stereoscopic images.

Further, in the present invention, since the focal lengths of the left and right lenses 201 and 202 automatically align with the surfaces of the left and right images L and R, stereoscopic observation is possible even when the stereoscopic viewer 200 moves freely over the stereoscopic image surface 106 as illustrated in FIG. 1.

Furthermore, such a stereoscopic viewer 200 forms a thin plate structure when the left and right lens plates 203 and 204 and the left and right horizontal supports 207 and 208 are folded as illustrated in FIG. 10C, so that the stereoscopic viewer 200 may be stored in the storage case 3 as illustrated in FIG. 3 to complete the stereoscopic story book 100 structure as illustrated in FIG. 2.

Therefore, the present invention may display, for example in science fiction novels, based on the central fold line 107, images and text related to novel contents on the left book page 105, and provide a plurality of left and right images L and R for stereoscopically observing related images on the right book page 106.

For stereoscopic cartoons, for example, general 2D cartoons and text may be displayed on one side based on the central fold line 107, while full-length stereoscopic cartoons may be provided on the other side using left and right images L and R for stereoscopic viewing.

Furthermore, since the stereoscopic viewer 200 may be separated from the stereoscopic story book 100 and configured as a separate book form, the present invention may also be applied to full-length stereoscopic cartoons provided as a series.

The left and right horizontal supports 207 and 208 of the stereoscopic viewer 200 are perpendicular to the surface of the stereoscopic story book 100, such that the left and right images L and R, the left and right horizontal supports 207 and 208, and the left and right lenses 201 and 202 simultaneously are aligned horizontally with the same optical axis, so that the focus is maintained regardless of the number of pages of the stereoscopic story book 100 as illustrated in FIG. 1 and FIGS. 7A, 7B, and 7C, and multiple stereoscopic screens may be viewed continuously without interruption of the story.

Therefore, the present invention comprises a W-shaped successively folded paper surface wherein the interior surfaces are adhered together to form a single page and the exterior surfaces include a text surface 105 comprising stereoscopic left and right images L and R or the text surface 105 and left and right images L and R, and both surfaces of the W-shaped paper surface are sequentially connected, with one side connected to the central fold line 107 and the other side connected to the book spine fold line 109, thereby providing the surfaces of the left and right images L and R in a horizontal state on each page.

The stereoscopic viewer 200 comprises the left and right lenses 201 and 202 provided at the top, and left and right horizontal supports 207 and 208 provided at the bottom of the central support 209 configured to have the same length as the focal length of the left and right lenses 201 and 202, and the left and right horizontal supports are configured as frames with interiors through which left and right images L and R are exposed.

The size of the left and right images L and R and the interior of the left and right horizontal supports 207 and 208 are configured to be the same size, and the surfaces of the left and right horizontal supports 207 and 208 and the left and right images L and R are horizontally aligned with each other such that the focus of the left and right lenses 201 and 202 is configured to align with the surfaces of the left and right images L and R, whereby the stereoscopic viewer 200 may observe the left and right images L and R as stereoscopic images while moving across the surfaces of the plurality of left and right images L and R.

Further, the configuration of the present invention may be combined with a book cover 1 structure, the stereoscopic viewer 200 may be separated and configured to be combined separately with a story book structure, and book pages 2 composed of left and right images L and R and text pages A may be separated and configured as a single book.

Therefore, the structure of the stereoscopic story book 100 of the present invention in which W-shaped forms are continuously formed may arbitrarily increase the number of pages, thereby enabling publication of various publications with diverse stories as stereoscopic story books, including short, medium and full-length, and series of stereoscopic cartoons, stereoscopic fantasy novels, stereoscopic full-length science fiction novels, and stereoscopic educational materials such as stereoscopic introduction to architecture and stereoscopic introduction to medicine, as well as stereoscopic travel guide story book.

[Description of symbols]

100: Stereoscopic story book
200: Stereoscopic viewer
1: Book cover
2: Book page
3: Storage case
101: Front cover
102: Back cover
103: Book spine (Seneka)
104: Page surface
105: Text surface
106: Stereoscopic image surface
107: Central fold line
108: Interior adhesive surface
109: Book spine fold line
201: Left lens
202: Right lens
203: Left lens plate
204: Right lens plate
205: Hinge
207: Left horizontal support
208: Right horizontal support
209: Central support
A: Text image
L: Left image
R: Right image

1. A stereoscopic story book in which a book page composed of left and right stereoscopic images constituted by multiple pages and a stereoscopic viewer are combined to provide a stereoscopic image and a story, wherein in the book page (2),
among paper surfaces which are successively folded in a w shape, both interior surfaces are adhered to each other to form one page, and both exterior surfaces are provided to include the stereoscopic left and right images (L, R) or a text surface (105), and a text surface (105) constituted by the stereoscopic left and right images (L, R), and
of both sides of the w-shaped paper surface, one side is connected to a central fold line (107) and the other side is connected to a book spine fold line 109 to provide surfaces of the left and right images (L, R) in a horizontal state for each page, and
in the stereoscopic viewer (200),
left and right lenses (201, 202) are provided at the top, and left and right horizontal supports (207, 208), configured as frames through which left and right images (L, R) are exposed therein, are provided at the bottom of a central support (209) configured to have the same length as the focal length of the left and right lenses (201, 202),
the left and right images (L, R), and an interior of the left and right horizontal supports (207, 208) are configured to have the same size, and
the left and right horizontal supports (207, 208) and surfaces of the left and right images (L, R) horizontally align with each other such that the focus of the left and right lenses (201, 202) is configured to align with the surfaces of the left and right images (L, R),
thereby enabling the stereoscopic viewer (200) to observe the left and right images (L, R) as stereoscopic images while moving on the surfaces of the multiple left and right images (L, R).

2. The stereoscopic story book of claim 1, wherein the configuration of claim 1 is configured in combination with a book cover structure.

3. The stereoscopic story book of claim 1, wherein the book page (2) is configured as a separate book, which is constituted by the left and right images (L, R) and text pages (A).
